(19) United States
(12) Patent Application Publication
(10) Pub. No.: US 2019/0009468 A1
(43) Pub. Date: Jan. 10, 2019

(54) HEATED AND ADAPTIVE BUILD PLATFORM FOR 3D PRINTERS

(71) Applicant: SD3D INC., San Diego, CA (US)

(72) Inventor: David Scott FEENEY, Dallas, TX (US)

(21) Appl. No.: 16/065,964

(22) PCT Filed: Dec. 30, 2016
(86) PCT No.: PCT/US2016/069509

§ 371 Date: Jun. 25, 2018

Related U.S. Application Data
(60) Provisional application No. 62/274,288, filed on Jan. 2, 2016.
(60) Provisional application No. 62/274,244, filed on Jan. 2, 2016.

(51) Int. Cl. B29C 64/245; B33Y 30/00; B29C 64/364; B33Y 40/00

(52) U.S. Cl. CPC B29C 64/245; B33Y 40/00; B29C 64/364; B33Y 30/00

(57) ABSTRACT

A multi-layer composite structure, or heated build platform, to serve as a build foundation for printing 3D objects and providing non-destructive, auto-ejection of the printed object. The heated build platform is comprised of one or more layers including a low surface energy thermoplastic layer, a high flatness and dimensional stability layer, a heat spreading layer, a high thermal density layer, a heater layer, an active convection cooling device, a frame, and a bed leveling device. The layers of the heated build platform are implemented to provide steady state operating conditions for printing 3D objects.

### CROSS REFERENCE TO RELATED APPLICATIONS

This application is a national stage application of international patent application PCT/US/16/69509, filed Dec. 30, 2016, which claims priority to U.S. Provisional Application No. 62/274,244 filed Jan. 2, 2016. The international patent application PCT/US16/69509 also claims priority to U.S. Provisional Patent Application No. 62/274,288 filed on Dec. 30, 2016, the entire contents of which are incorporated herein by reference.

### BACKGROUND

Additive manufacturing, otherwise known as three-dimensional (3D) printing, is a technique used for manufacturing 3D objects by depositing successive layers of a material. A particular type of 3D printing, fused filament fabrication, utilizes thermoplastic build material that is extruded through the printer head to form the printed object upon a suitable surface, such as a substrate or the surface of the build platform. The utilization of 3D printing objects has been rapidly growing due to the increased speed and decreased cost with which a large variety of objects can be manufactured.

However, utilizing 3D manufacturing for producing low volume runs, or objects that are sensitive to print environment conditions, can present several challenges. For example, if an object must be forcibly removed from a print environment recalibration may be required in between each run, which is both costly and time-consuming, or may distort the object. In addition, surface treatment is often required for the build material to initially adhere to the 3D printing surface. A surface treatment before each printing run can require additional time and cost. In lieu of recalibration and printing surface treatments between runs, some might opt for a dissolvable print environment which can be costly and impracticable.

Additionally, controlling sensitive build environment conditions can be energy intensive. Large temperature gradients both in and around the printing system often cause defects and distortion of the object both during printing and upon removal. Thus, conventional 3D printing systems may require additional energy to regulate the temperature of the environment surrounding the printing system. This additional energy expenditure is both costly and harmful to the environment. For example, additional thermal energy may be required to heat or cool a portion of the print area to reduce the risk of defects upon removal or in the final product. In many ways, producing objects via conventional fused filament fabrication 3D printing processes can often result in expensive, high energy, and low-reliability production runs.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example 3D print system according to some implementations.

FIG. 2 illustrates an example adaptive build environment for 3D printing according to some implementations.

FIG. 3 illustrates another example adaptive build environment for 3D printing according to some implementations.

FIG. 4 illustrates a side view of the example panel of the second adaptive build environment of FIG. 3.

FIG. 5 illustrates a top view of the example panel of the second adaptive build environment of FIG. 3.

FIG. 6 illustrates a perspective view of the example panel of the adaptive build environment of FIG. 2.

FIG. 7 illustrates a perspective view of the example panel of the adaptive build environment of FIG. 3.

FIG. 8 illustrates an example heated build platform for 3D printing according to some implementations.

FIG. 9 illustrates a side view of the heated build platform of FIG. 8.

FIG. 10 is a top view of the heated build platform of FIG. 8.

FIG. 11 illustrates an example architecture of the control system of the 3D print system of FIG. 1.

### DETAILED DESCRIPTION

The present disclosure is directed to, among other things, techniques, systems, and materials for producing objects using an additive manufacturing system, or 3D printing system. In some cases, an adaptive build environment may be implemented to produce 3D printed objects in an environment that is controlled and isolated both from outside conditions and within the print environment itself. In other cases, a heated build platform may be implemented to serve as a build foundation for printing 3D objects and provide non-destructive, auto-ejection of the printed object.

The techniques, systems, and materials described herein improve the energy efficiency, cost, reliability, and quality of the 3D printing process. For example, adaptive build environment embodiments described herein may isolate the 3D printing system from the external environment with one or more physical barriers. The physical barriers may also be capable of dynamically altering the insulation properties of the build environment. For example, a 3D printing system in a high traffic area may experience additional external heat from changing conditions in the external environment, such as movement of individuals or workers in and around the print area. Also, external heating and cooling devices around the print area, for example an air-conditioning unit located near the 3D printing system, may alter the temperature gradient of the print area.

In addition, the one or more physical barriers may also serve to regulate the temperature gradient of the 3D printing system. For example, heat may build up in certain areas of the 3D printing system where thicker portions of the object require more lengthy print times. The physical barriers help, in some cases, to distribute this excess heat throughout the adaptive build environment to create steady state operating conditions. Thus, 3D objects can be printed without the risks of warping or delamination present in conventional 3D printing systems.

In addition, the adaptive build environments described herein may also utilize existing process energy from the vicinity of the build area to help regulate the temperature gradient of the 3D printing system. As discussed above, if an object is being printed that has a very thick portion, excess heat may build up in the section of the print area where that portion of the object is being printed. The adaptive build environment may be able to utilize this excess heat and disperse or spread the heat to another section of the print area to regulate the heat gradient and prevent deformation of the object.

In some implementations, the adaptive build environment may include one or more modular panels. For example, the illustrated examples shown below has five panels. Each panel may include an active cooling subsystem having a first thermal heat sink component, a second thermal heat sink component, a convection generating device, an inner plate, and an outer plate. In some implementations, a segmented gas and fluid guidance system may be included in one or more of the panels of the adaptive build environment in place of, or in addition to, the second thermal heat sink.

In some embodiments, the active cooling subsystem may be a thermo-electric cooler and is configured to pump and disperse excess heat across the panel. The active cooling subsystem may also have a first thermal heat sink designed to transfer heat generated by the 3D printing process to a fluid medium to help regulate the temperature gradient of the 3D printing environment.

In further embodiments, a second thermal heat sink component may be implemented. This second thermal heat sink may include a flat panel adjacent to an outer panel of the adaptive build environment. This additional thermal heat sink component may also serve to transfer heat generated by the 3D printing process to help create steady state ambient conditions for the 3D printing system.

In some examples, the convection generating device may include a fan to generate air flow throughout the panel or may utilize fluids. The convection generating device serves as the source of fluid or gas that, in conjunction with the other components of the adaptive build environment, is utilized to regulate the temperature gradient of the adaptive build environment and the 3D printing system contained therein.

In other examples, the adaptive build environment may implement a segmented gas or fluid guidance system. The segmented gas or fluid guidance system may operate in conjunction with the convection generating device to guide the fluid and/or gas through a panel of the adaptive build environment. This segmented gas and/or fluid guidance system may include one or more guide beams. The guide beams of the segmented gas or fluid guidance system may also serve to insulate the adaptive build environment, thus helping to insulate the 3D printing system housed therein and isolate the system from outside conditions.

In some embodiments, the 3D printing system may also implement a heated build platform. In particular, the heated build platform is a multi-layer composite heated build platform implementing one or more layers to help provide reliable, steady state operating conditions. The heated build platform as described herein provides a near-zero gradient surface, upon which to print a 3D object, that is capable of being automatically ejected from the 3D printing system during the removal process. Thus, the use of the heated build platform significantly reduces the risk of deformation, delamination, warping and other defects.

In some examples, the heated build platform may include a frame, bed leveling devices, a low surface energy thermoplastic layer, a high flatness and dimensional stability layer, a heat spreading layer, a high thermal density layer, a heater layer, and an active convection cooling device. The frame and bed leveling devices may be configured to keep the heated build platform steady and balanced to reduce printing defects.

In some embodiments, the low surface energy thermoplastic layer may serve as the top layer of the heated build platform and is configured to give a chemical bond between the layer and the build material. At higher temperatures, the low surface energy thermoplastic layer may have a high bondage to the build material. This allows for a bond between the low surface energy thermoplastic layer and the build material without the need for a surface treatment conventionally required to create an initial bond. At lower temperatures, the low surface energy thermoplastic layer may have a low bondage to the build material. The low surface energy thermoplastic layer may also have a low shrinkage rate when compared to high shrinkage thermoplastics commonly used as build material in 3D printing. This difference in shrinkage rates, along with the low bondage to the build material at cooler temperatures, allows for the 3D print object to naturally disengage, or auto-eject, during the cooling and removal process, thus eliminating the need for forcible, manual removal conventionally required.

In other embodiments, the high flatness and dimensional stability layer serves as a rigid and flat layer to provide flatness within the heated build platform. In some examples, the high flatness and dimensional stability layer may be form fitted to the low surface energy thermoplastic layer.

In some examples, the heat spreading layer serves as a thin plate configured to spread heat through the heated build platform and create an ambient, steady state printing condition. In other examples, the heat spreading layer may be configured as guide, path, or pattern formed from particular materials to cause the heat to spread or move away from a particular location or hot spot.

In other examples, the high thermal density serves to disperse heat from the heater layer. The heater layer serves as the heat source for the heated build platform. The high thermal density layer is configured to disperse the heat provided by the heat layer to create a more moderate temperature gradient.

In further examples, the active convection cooling device may be implemented near or adjacent to the bottom surface of the heater layer. The active convection cooling device may be located at the center of the bottom of the heater layer and may be configured to reverse the natural temperature gradient created by the heater layer. The active convection cooling device may include a fan, or any other active heat transfer device, as well as a heat sink component. In some cases, the active convection cooling device may serve to disperse the heat from the center of the heater layer to the corners of the heater layer. In lieu of the active convection cooling device, one or more heaters may be located at the corners of the heater layer. Or, as another example, a heater layer may be implemented without a center to maintain heat at the corners of the layer.

These and other implementations are described below in more detail with reference to the representative architecture illustrated in the accompanying figures.

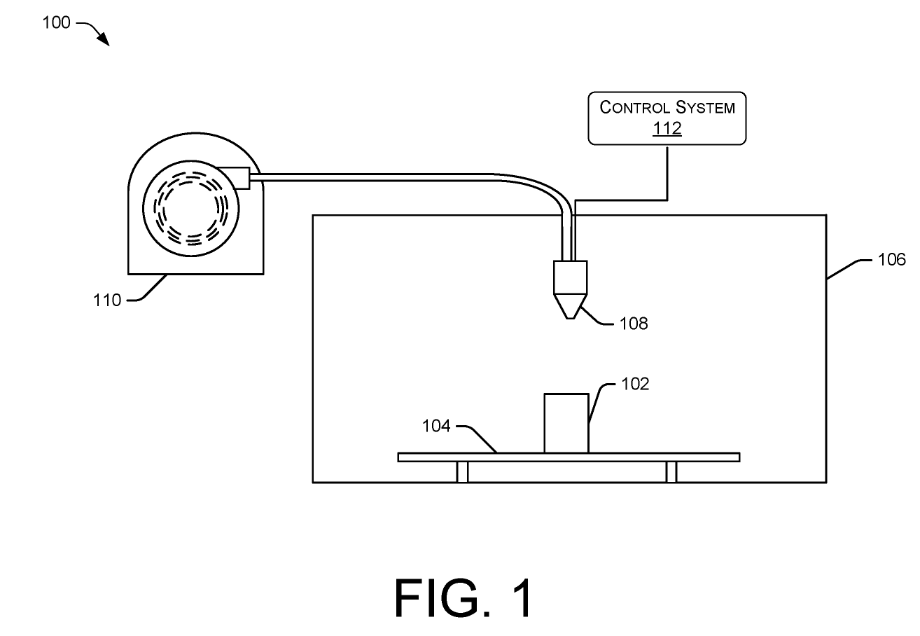

FIG. 1 illustrates an example a 3D print system 100. The 3D print system 100 is configured to manufacture an object 102 by 3D printing, or additive manufacturing, techniques such as fused filament fabrication. For example, the 3D print system 100 can be used to produce the object 102 by depositing layers of a build material on a build platform 104. In some embodiments, the object may be removed by hand, by a process involving specialized tooling, or by auto-ejection techniques. For example, in an embodiment, the composition of the top layer of the build platform 104, along with other components of the build platform 104, may aid in the removal of the object 102 by auto-ejection.

In the illustrated example, the 3D print system 100 can include a 3D print environment 106 surrounding the build platform 104 and housing various components of the 3D print system 100. Various examples of environments will be described below in greater detail and may implement one or more panels. The panels may be formed from a variety of materials such as metals, ceramics, or a combination thereof.

In some examples, the 3D print system 100 can also include an extrusion head 108. In some embodiments, the extrusion head 108 is configured to extrude build material, layer by layer, to form the object 102 on the surface of the build platform 104. The extrusion head 108 can be any type of extrusion head having an opening, such as a nozzle or spout, able to emit the building material layers to form the object 102. The opening of the extrusion head 108 may vary in diameter dependent upon the building material and the size of the object 102 being formed. In some implementations, the extrusion head 108 may move within the 3D print environment 106 to deposit the build material at various desired locations in assertions with the object 102 and/or the build platform 104.

In some embodiments, the 3D print system 100 can also include a material source 110 to store the build material used to form object 102. The material source 110 can be coupled to the extrusion head 108 by a tubing system or other suitable connection system. In some examples, the supply of building material from the material source 110 to the extrusion head 108 can be turned off and on and both driven forward and retracted backward. The supply rate may also be controlled by a drive unit operable to control the increase and decrease the flow of build material to the extrusion head 108. In some implementations, the supply rate may range from 0-100 mm3 in the forward direction when the extrusion head 108 is heated significantly beyond the glass transition temperature of the material source 110. In further implementations, the supply rate in the reverse direction may exceed the supply rate in the forward direction as the material source 110 does not require a pushing force through the nozzle orifice of the extrusion head 108 when the extrusion head 108 is operating in the reverse direction.

In further embodiments, the 3D print system 100 can include a control system 112. The control system 112 can include one or more hardware processor devices and one or more physical memory devices. The one or more physical memory devices can be examples of computer storage media for storing instructions which are executed by the one or more processors to perform various functions. The one or more physical memory devices can include both volatile memory and non-volatile memory (e.g., RAM, ROM, or the like). The one or more physical memory devices can also include one or more cache memory devices, one or more buffers, one or more flash memory devices, or a combination thereof. The 3D print system 100 can also include one or more additional components, such as one or more input/output devices. For example, the 3D print system 100 can include a keyboard, a mouse, a touch screen, a display, speakers, a microphone, a camera, combinations thereof, and the like. The 3D print system 100 can also include one or more communication interfaces for exchanging data with other devices, such as via a network, direct connection, or the like. For example, the communication interfaces can facilitate communications within a wide variety of networks or connections, such as one or more wired networks or wired connections and/or one or more wireless networks or wireless connections.

In some examples, the control system 112 can include, be coupled to, or obtain data from a computer-aided design (CAD) system to provide a digital representation of the object 102 to be formed by the 3D print system 100. Any suitable CAD software program can be utilized to create the digital representation of the object 104. For example, a user can design, using a 3D modeling software program executing on a host computer, an object having a particular shape with specified dimensions, such as the object 104, that is to be manufactured using the 3D print system 100. In order to translate the geometry of the object 102 into computer-readable instructions or commands usable by a processor or a suitable controller in forming the object 102, the control system 112 can mathematically slice the digital representation of the object 102 into multiple horizontal layers. The control system 112 can then design build paths along which build material is to be deposited in a layer-by-layer fashion to form the object 102.

In further examples, the control system 112 can manage and/or direct one or more components of the 3D print system 100, such as the extrusion head 108, by controlling movement of those components according to a numerically controlled computer-aided manufacturing (CAM) program along computer-controlled paths. Optionally, the control system 112 can control one or more components of the 3D print system 100 to move according to script written in a programming language. The script can be used to produce code in a numerical programming language, such as G-code, that the control system 112 can execute. The movement of the various components of the 3D print system 100, such as the extrusion head 108, can be performed by the use of stepper motors, servo motors, microcontrollers, combinations thereof, and the like.

In one specific example, the control system 112 may be configured to monitor and adjust various factors associated with extruding the object 102. For example, the control system 112 may monitor a temperature associated with the interior of the 3D print environment 106 and to control a convection system (not shown) to assist in maintaining an even heat distribution or gradient within the 3D print environment 106.

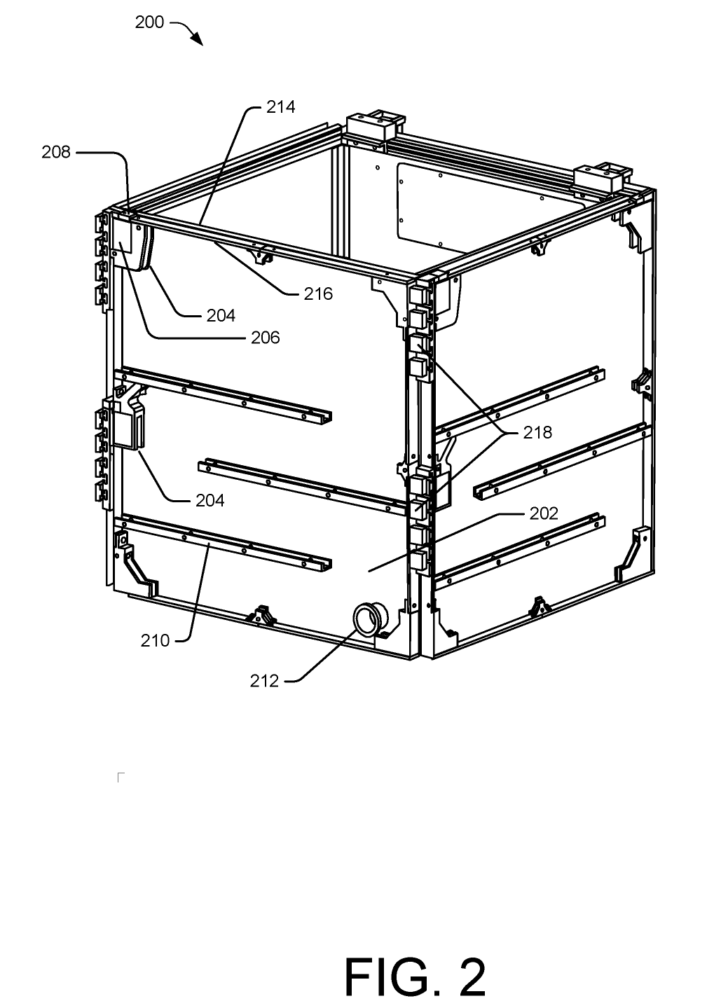

Referring now to FIG. 2, an example adaptive build environment 200 for 3D printing is illustrated. The adaptive build environment 200 may implement one or more panels that are modular in nature. The adaptive build environment 200 shown in FIG. 2 implements five panels in a modular assembly. Each panel, such as illustrative panel 202, can include an active cooling subsystem 204 having a thermal heat sink component 206, a convection generating device 208, a segmented gas or fluid guidance system 210, a gas or fluid exit 212, an inner plate 214, an outer plate 216. In some embodiments, each panel of the adaptive build environment 200 is sized to surround the build area and enclose all 3D print system components, while being tailored to efficiently utilize the required space for the 3D print system as a whole. The actual arrangement, size, and distribution of the components may vary dependent on the required characteristics of each adaptive build environment.

In some examples, the active cooling subsystem 204 of the panel 202 can be an electric heat pump or, more specifically, a thermo-electric cooler. In other examples, the active cooling subsystem can distribute, or pump, heat across the panel 202 to create a difference in temperature across the panel 202. In some examples, the temperature difference created by the active cooling subsystem 204 across panel 202 may range from 20 to 80 degrees Celsius, however, in other examples the temperature difference may vary depending on the build material being used and other printing considerations. Additionally, the active cooling subsystem 204 may include a thermal heat sink 206. The thermal heat sink 206 is configured to transfer heat generated by the 3D printing process to a fluid medium to help regulate the temperature gradient of the 3D printing environment 200. For example, heat generated during the 3D printing process can be transferred by the thermal heat sink 206 to a liquid or air coolant to help disperse the heat more evenly across the panel 202 or the adaptive build environment 200. In some embodiments, the thermal heat sink may be constructed of zinc, copper, aluminum, brass, bronze, silver, steel or any other material with thermal conductivity higher than 25 W/(m·K).

In some embodiments, the adaptive build environment 200 may implement additional active cooling subsystems similar to the active cooling subsystem 204. For example, if the adaptive build environment 200 is sufficiently large, if the printing process generates high amounts of heat, if extreme temperature gradients are produced during the printing process, or if the object being produced varies greatly in structure and thickness, multiple active cooling systems may be required to improve the 3D print system response times to transient thermal conditions. In addition, by utilizing multiple active cooling systems are implemented, system response times to transient thermal conditions may be improved.

In other examples, the convection generating device 208 of panel 202 may implement a fan or any component capable of transporting fluids or gases through the cavities of the panel 202. In some examples, the convention generating device 208 may also serve as the source of fluid or gas being fed into the panel 202.

In further examples, the segmented gas or fluid guidance system 210 of panel 202 may implement one or more guide beams to guide the flow of gas or fluid within the panel 202. The segmented gas or fluid guidance system 210 serves as an active convention system for the gas or fluid supplied by the convection generating device 208. In some examples, the segmented gas or fluid guidance system 210 may guide the gas or fluid to the gas or fluid exit 212, for example to be re-introduced into the system 210 via the convention generating device 208. In some examples, the gas or fluid exit 212 is implemented at a location of the panel 202 opposite that of the convection generating device 208. In other examples, the guide beams of the segmented gas or fluid guidance system 210 may serve as insulating structures of panel 202 configured to retain heat generated within the panel 202 or within the 3D printing environment 200.

In other implementations, the panel 202 may further comprise an inner plate 214 and an outer plate 216. For example, the inner plate 214 may be located on a first surface of a panel, such as panel 202. Similarly, the outer plate 216 may located on a second surface of panel 202, with the first surface and the second surface being opposite each other. In some embodiments, the inner plate 214 may be composed of a material with a rigidity or shear modulus of at least 5 GPa. For example, the inner plate 214 may be composed of zinc, copper, aluminum, brass, bronze, silver, steel, a combination thereof, or other materials known to be both rigid and absorb and/or transfer thermal energy. In some embodiments, the outer plate 216 may be composed of a material with a rigidity of at least 5 GPa and a low thermal conductivity ranging from 0.001-10 W/(m·K). For example, the outer plate 216 may be composed of plastic such as acrylic, Acrylonitrile Butadiene Styrene (ABS), Polycarbonate (PC), Polyetherimide (PEI), Polyethylene Terephthalate (PET), Polyether ether ketone (PEEK), Polyphthalamide (PPA), and Polyphenylene sulfide (PPS) along with many other plastic combinations and alloys. Additionally, the outer plate 216 may be composed of any organic material, such as wood, that satisfies the rigidity and thermal conductivity range requirements.

In some examples, the one or more modular panels are connected or attached to each other through one or more locking mechanisms. For example, in the illustrated example, locking mechanism 218 is used to attached panel 202 to one or more of the additional panels of adaptive build environment 200. In some embodiments, the locking mechanism 218 may also be composed of one or more thermal heat sink components. In some cases, the modular panels may be configured in multiple arranges using the locking mechanism 218.

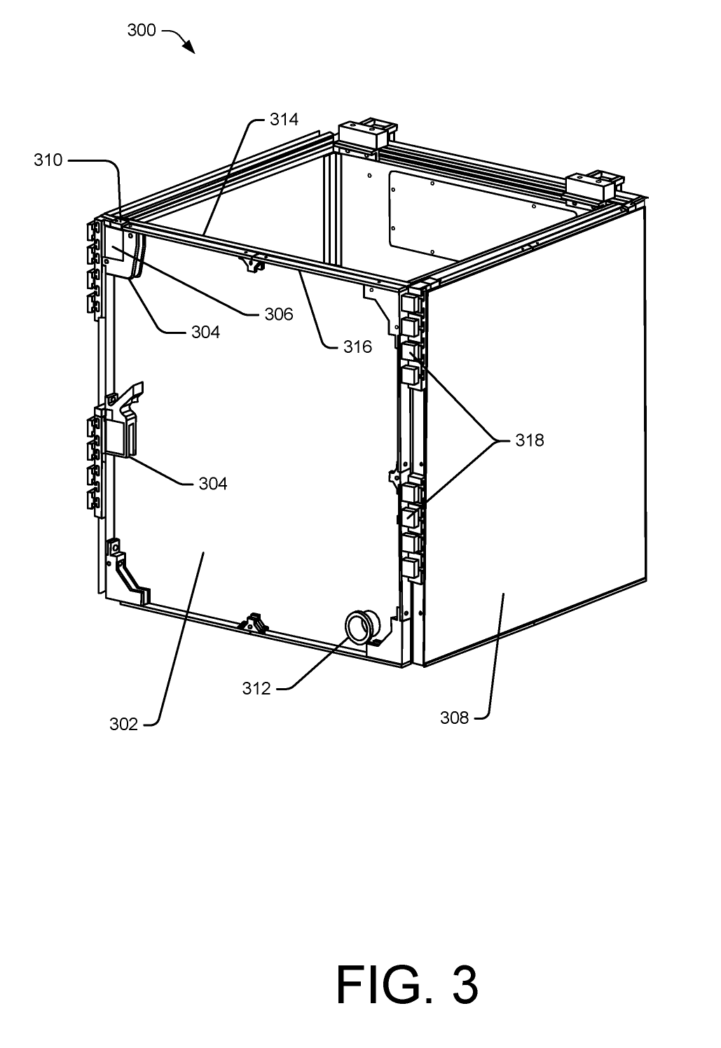

FIG. 3 illustrates another example adaptive build environment for 3D printing. Similar to the adaptive build environment 200 of FIG. 2, the adaptive build environment 300 may implement one or more panels that are modular in nature. The adaptive build environment 300 shown in FIG. 3 implements five panels in a modular assembly. However, other panel assemblies may be utilized implementing more or less panels in various geometric embodiments. For example, seven panels (including the build platform) may be implemented to construct a rectangular adaptive build environment.

each panel, such as illustrative panel 302, can include an active cooling subsystem 304 having a first thermal heat sink component 306, a second thermal heat sink component 308, a convection generating device 310, a gas or fluid exit 312, an inner plate 314, and an outer plate 316. In some embodiments, each panel of the adaptive build environment 300 is sized to surround the build area and enclose all 3D print system components, while being tailored to efficiently utilize the required space for the 3D print system as a whole. The actual arrangement, size, and distribution of the components may vary dependent on the required characteristics of each adaptive build environment.

In some examples, as described above, the active cooling subsystem 304 of the panel 302 can be an electric heat pump or, more specifically, a thermo-electric cooler. In some examples, the active cooling subsystem can distribute, or pump, heat across the panel 302 to create a difference in temperature across the panel 302. In some examples, the temperature difference created by the active cooling subsystem 304 across panel 302 may range from 20 to 80 degrees Celsius, however, the temperature difference may vary based on the build material and other printing considerations. In some implementations, the active cooling subsystem 304 may include a thermal heat sink 306 to absorb heat and/or a conductive material to spread heat across the panel 302. The thermal heat sink 306 is configured to transfer heat generated by the 3D printing process to a fluid medium to help regulate the temperature gradient of the 3D printing environment 300. For example, heat generated during the 3D printing process may be dispersed by the thermal heat sink 306 to a liquid or air coolant to help regulate the temperature gradient of the adaptive build environment 300. In some embodiments, the thermal heat sink may be constructed of zinc, aluminum, brass, bronze, copper based alloys, nickel based alloys, magnesium, graphite, a combination thereof, or other materials known to absorb and/or transfer thermal energy. In some examples, the panel 302 may also include heat spreading materials such aluminum, copper, copper based alloys, or other materials known to distribute heat.

Similar to the adaptive build environment 200 shown in FIG. 3, the adaptive build environment 300 may implement additional active cooling subsystems similar to the active cooling subsystem 304.

In other examples, the convection generating device 310 of panel 302 may implement a fan or any component capable of transporting fluids or gases through the cavities of the panel 302. In some examples, the convention generating device 310 may also serve as the source of fluid or gas being fed into the panel 302.

In other implementations, the panel 302 may further comprise an inner plate 314 and an outer plate 316. The inner plate 314 may be located on a first surface of panel 302. The outer plate 316 may located on a second surface of panel 302, with the first surface and the second surface being opposite each other. In some embodiments, the inner plate 314 may be composed of a material with a rigidity of at least 5 GPa. For example, the inner plate 314 may be composed of aluminum, brass, bronze, copper, copper based alloys, and nickel based alloys steel or zinc. In some embodiments, the outer plate 316 may be composed of a material with a rigidity of at least 5 GPa and a low thermal conductivity ranging from 0.001-10 W/(m·K). For example, the outer plate 316 may be composed of plastic such as Acrylonitrile Butadiene Styrene (ABS), Polycarbonate (PC), Polyetherimide (PEI), Polyethylene Terephthalate (PET), Polyether ether ketone (PEEK), Polyphthalamide (PPA), and Polyphenylene sulfide (PPS) along with many other plastic combinations and alloys. Additionally, the outer plate 216 may be composed of any organic material, such as wood, that satisfies the rigidity and thermal conductivity range requirements.

In some embodiments, the second thermal heat sink 308 may be adjacent to an outer plate 316 and may serve to transfer heat generated by the 3D printing process to a fluid medium to help regulate the temperature gradient of the 3D printing environment 300. For example, the second thermal heat sink 308 may be attached or mounted to the outer plate 316. The second thermal heat sink 308 may be constructed of a material having a thermal conductivity of at least 25 W/(m·K). For example, the second thermal heat sink 308 may be composed of aluminum, brass, bronze, copper, copper based alloys, and nickel based alloys steel or zinc

In some examples, the one or more modular panels are connected or attached to each other through one or more locking mechanisms. For example, in the illustrated example, locking mechanism 318 is used to attached panel 302 to one or more of the additional panels of adaptive build environment 300. In some embodiments, the locking mechanism 318 may also be composed of one or more thermal heat sink components.

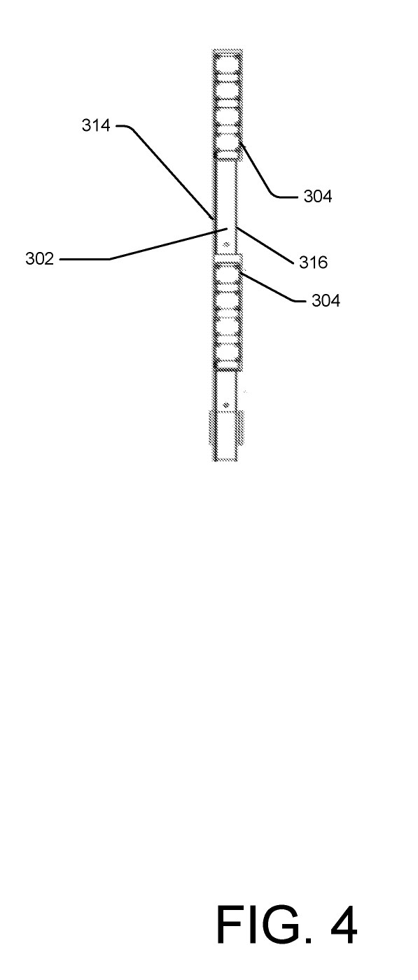

FIG. 4 illustrates a side view of the example panel of the second adaptive build environment of FIG. 3. In the illustrated example, the panel 302 implements the active cooling subsystem 304 comprising, the inner plate 314 and the outer plate 316. As described above with respect to FIG. 3, the active cooling subsystem 304 can be an electric heat pump or, more specifically, a thermo-electric cooler. For example, the active cooling subsystem can distribute, or pump, heat across the panel 302 to create a difference in temperature across the panel 302. The inner plate 314 and the outer plate 316 may be located on a first and second surface, respectively, of panel 302, with the first and second surface being opposite each other.

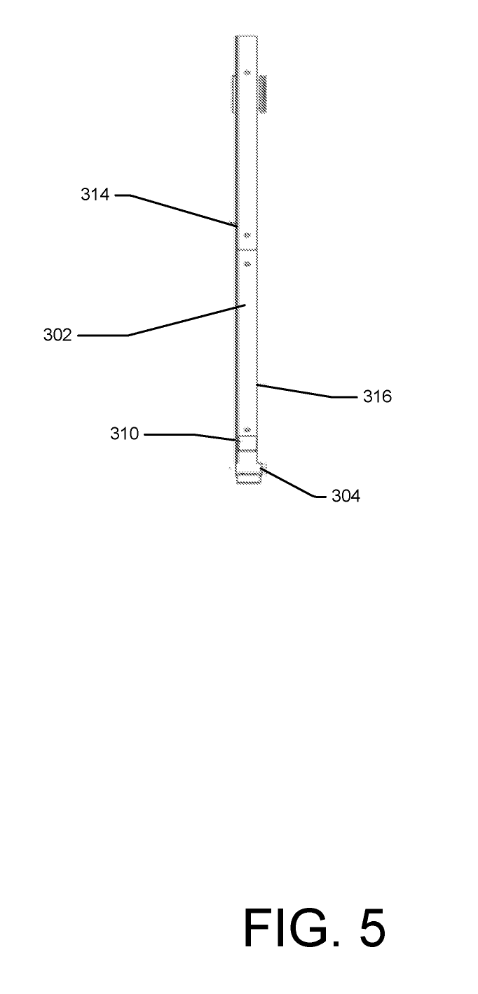

FIG. 5 illustrates a top view of the example panel of the second adaptive build environment of FIG. 3. In the illustrated example, the panel 302 implements the active cooling subsystem 304, the convection generating device 310, the inner plate 314, and the outer plate 316. As describe above with respect to FIGS. 3 and 4, the active cooling subsystem 304 can be an electric heat pump or, more specifically, a thermo-electric cooler. Also described above, the convection generating device 310 of panel 302 may implement a fan or any component capable of transporting fluids or gases through the cavities of the panel 302. Additionally, in some embodiments, the convention generating device 310 may also serve as the source of fluid or gas being fed into the panel 302. Further, in some examples, the inner plate 314 and the outer plate 316 may be located on a first and second surface, respectively, of panel 302, with the first and second surface being opposite each other.

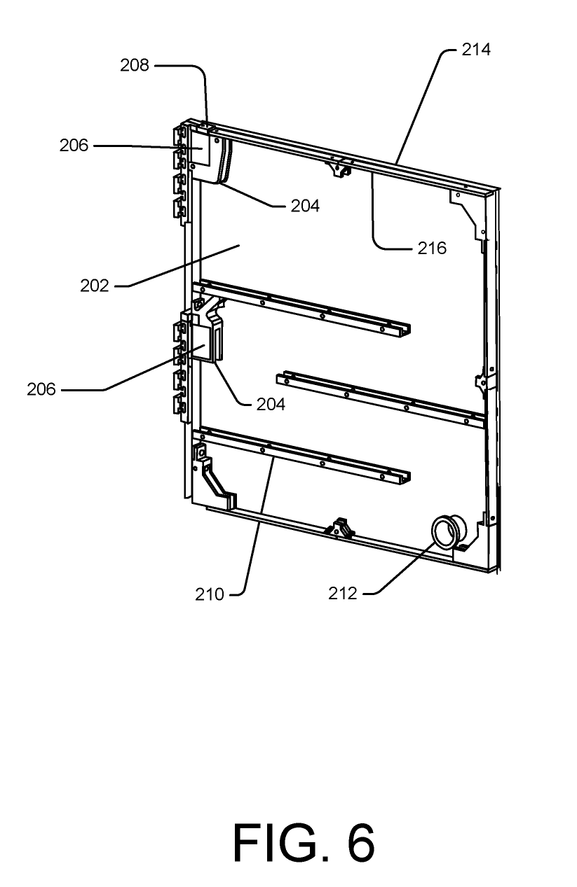

FIG. 6 illustrates a perspective view of the example panel of the adaptive build environment of FIG. 2. The first adaptive build environment 200 may implement one or more panels that are modular in nature. The adaptive build environment 200, shown and described above with respect to FIG. 2, implements panel 202 including an active cooling subsystem 204 having a thermal heat sink component 206, a convection generating device 208, a segmented gas or fluid guidance system 210, a gas or fluid exit 212, an inner plate 214, an outer plate 216.

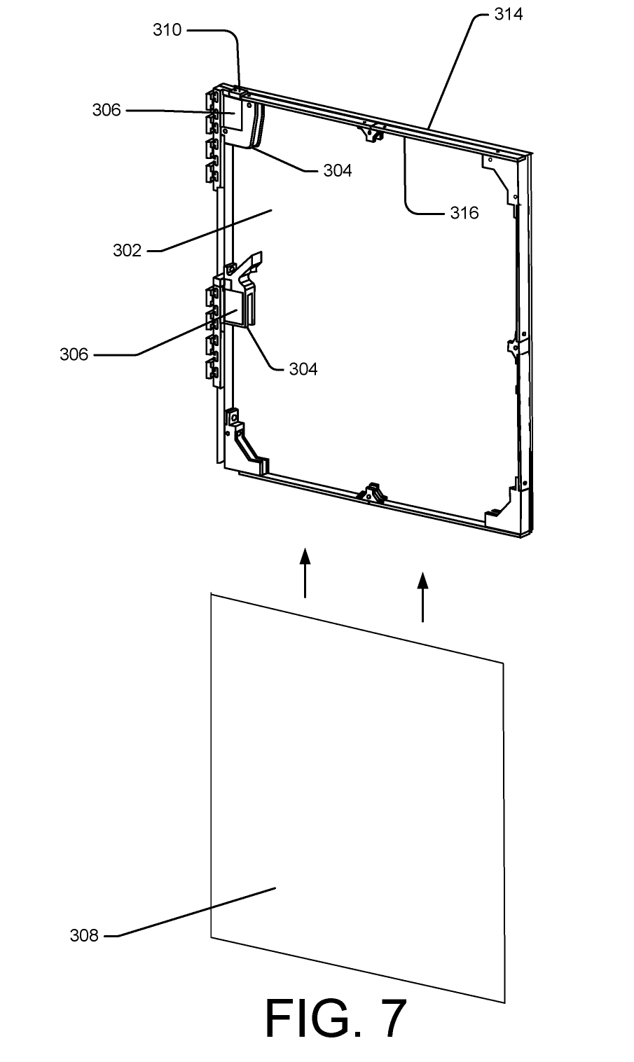

FIG. 7 illustrates a perspective view of the example panel of the adaptive build environment of FIG. 3. The second adaptive build environment 300 may implement one or more panels that are modular in nature. The adaptive build environment 300, shown and described above with respect to FIG. 3, implements panel 302 including an active cooling subsystem 304 having a first thermal heat sink component 306, a second thermal heat sink component 308, a convection generating device 310, a gas or fluid exit 312, an inner plate 314, and an outer plate 316.

In some examples, the second thermal heat sink component 308 may be adjacent to the outer plate 316. For example, the second thermal heat sink 308 may be attached, adhered to, or mounted to the outer plate 316. In some embodiments, the second thermal heat sink 308 may be constructed of a material having a thermal conductivity ranging from 25 W/(m·K). For example, in some examples, the second thermal heat sink 308 may be composed of aluminum, brass, bronze, copper, copper based alloys, and nickel based alloys steel or zinc.

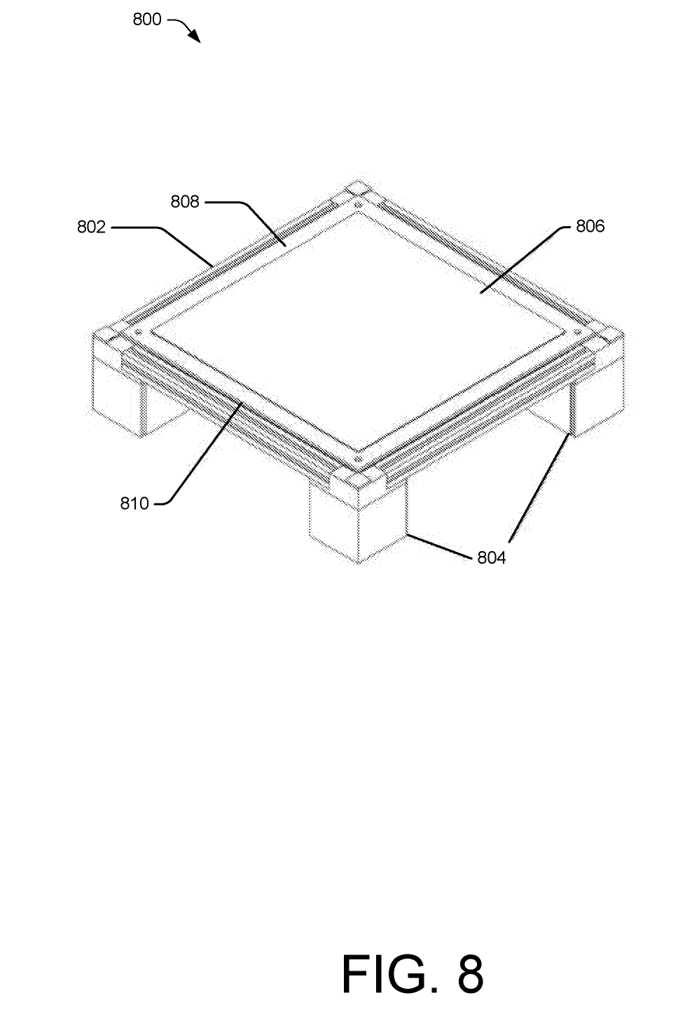

FIG. 8 an example of a heated build platform 800 for 3D printing is illustrated. The heated build platform 800 may implement one or more layers, a frame 802, and bed leveling devices 804. The bed leveling devices 804 may serve to level the heated build platform 800 and, along with the frame 802, ensure a stable build platform for the 3D printing process. While the components of the heated build platform 800 are illustrated in a certain order as shown, the layers of the heated build platform 800 may vary in arrangement in other embodiments not shown.

In the illustrated example, the heated build platform 800 implements five layers in a modular composite construction. The five layers of the heated build platform 800 include a low surface energy thermoplastic layer 806, a high flatness and dimensional stability layer 808, a heat spreading layer 810, a high thermal density layer (not shown), a heater layer (not shown), and an active convection cooling device (not shown). In some examples, the five layers of the heated build platform 800 may be bonded or laminated with a high strength and high temperature adhesive. For example, adhesives such as a thermal epoxy or transfer tape with supplier specified operating temperatures of at least twenty degrees Celsius (20 C) higher than the maximum intended operating temperature of the build platform 800 may be used. The high thermal density layer, the heater layer, and the active convection cooling device are more clearly depicted in FIG. 8 and will be described in detail with respect to that figure.

In some embodiments, the low surface energy thermoplastic layer 806 is implemented as the top surface layer of the heated build platform 800. In some examples, the low surface energy thermoplastic layer 806 provides a chemical bond with the build material being extruded to form the 3D print object. The low surface energy thermoplastic layer 806 may be composed of Polyetherimide (PEI), Polyetherether ketone (PEEK), Polyphthalamide (PPA), Polyphenylene sulfide (PPS), or any other high temperature plastics and their fiber reinforced alternatives with a low surface energy, such as those below 75 dynes/cm. For example, at higher temperatures, such as above the glass transition temperature, there may be a high level of bonding between the low surface energy thermoplastic layer 806 and the build material. At lower temperatures, such as below the glass transition temperature, there may be a low level of bonding between the low surface energy thermoplastic layer 806 and the build material. More specifically, the low surface energy thermoplastic layer 806 is typically reinforced with glass reinforced composites, resulting in a lower shrinkage rate than the build material. As the temperature of the build material cools, the printed object may experience a high shrinkage rate. In some cases, the build material may be selected to cause a threshold differential in the shrinkage rate as compared to the shrinkage rate of the low surface energy thermoplastic layer 806. The low bondage at lower temperatures, along with the difference in shrinkage rates between the low surface energy thermoplastic layer 806 and the printed object, may allow for the object to naturally disengage and detach from the surface of the low surface energy thermoplastic layer 806 as the object cools without causing damage to either the printed object or the heated build platform 800.

In other embodiments, the high flatness and dimensional stability layer 808 is disposed directly below the low surface energy thermoplastic layer 806 in the heated build platform 800. In the illustrated example, the high flatness and dimensional stability layer 808 is rigid in nature and very flat and may be composed of types of glass or rigid metals with a surface flatness tolerance of less than 0.5 millimeters (mm). The high flatness and dimensional stability layer 808 is implemented to provide a flatness to the heated build platform 800 and provide stability. In some examples, the low surface energy thermoplastic layer 806 is very thin, enabling the low surface energy thermoplastic layer 806 to be form fitted to the high flatness and dimensional stability layer 808. In other examples, the high flatness and dimensional stability layer 808 and the low surface energy thermoplastic layer 806 may be implemented as one layer in the heated build platform 800.

In further embodiments, the heat spreading layer 810 may be disposed directly below the high flatness and dimensional stability layer 808 in the heated build platform 800. In the illustrated example, the heat spreading layer 810 provides a layer in the heated build platform 800 configured to disperse heat throughout the heated build platform 800. For example, the heat spreading layer 810 may consist of a thin plate, of greater dimensions than the print area associated with the heated build platform 800. The thin plate may be configured to diffuse heat that is generated during the 3D printing process and/or by the 3D printing components. In some examples, the heat spreading layer 810 may be composed of any material with high thermal conductivity, such as those greater than 25 watts per meter Kelvin (W/m·K). For example, the heat spreading layer 810 may be composed of a metal, such as aluminum, brass, bronze, copper, copper based alloys, and nickel based alloys steel or zinc, among others.

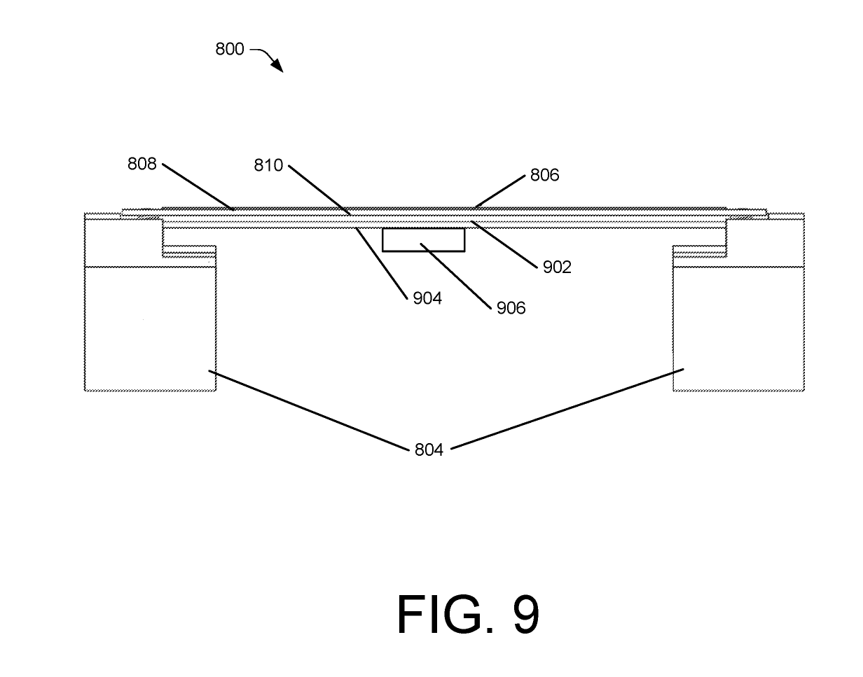

FIG. 9 illustrates a side view of the heated build platform 800 of FIG. 8. In the illustrated example, the heated build platform 800 further depicts the high thermal density layer 902, the heater layer 904, and an active convection cooling device 906 along with the bed leveling devices 804, the low surface energy thermoplastic layer 806, the high flatness and dimensional stability layer 808, and the heat spreading layer 810 described above with respect to FIG. 8.

In some embodiments, the high thermal density layer 902 is disposed below the heat spreading layer 810 and above the heater layer 904. In some examples, similar to the heat spreading layer 810, the high thermal density layer 902 may be configured to provide a layer in the heated build platform 800 for dispersing heat. The heater layer 904 may provide heat to the heated build platform 800, thus creating a natural heat gradient. The high thermal density layer 902 may be composed of a high thermal material, such as natural stone, ceramic, porcelain, or any other rigid material with high thermal capacity, such as those greater than 0.25 kilojoule per kilogram Kelvin (kJ/kg K), that is capable of dispersing the heat originating from the heater layer 904. The dispersion of the heat from heater layer 904 by the high thermal density layer 902 may serve to create a lower temperature gradient across the layers of the heated build platform 800. In some examples, the heater layer 904 may be composed of elements capable of reaching and maintaining temperatures elevated above ambient levels. Examples of the heater layer 904 composition include resistive heaters, induction heaters, and thermoelectric heating devices, among others.

In some examples, the active convection cooling device 906 may be disposed adjacent to the bottom surface heater layer 904. The active convection cooling device 906 may be located below the center of the heater layer 904 and may include a fan, or any other active heat transfer device, and a heat sink component and may be disposed in the center of the bottom surface of the heater layer 904. The active convection cooling device 906 may serve to invert the natural gradient of the heater layer 904. For example, the heater layer 904 may create a natural heat gradient originating at the center of the heater layer 904 where the heat originates. By implementing an active convection cooling device 906, the active convection cooling device 906 may invert the natural heat gradient of the heater layer 904 and disperse the heat to the corners of the heater layer 904. Additionally, at the top surface of the heater layer 904, the heat generated may remain at the center of the heater layer 904. For example, heat centered on the top surface of the heater layer 904 may be dispersed to the corners of the bottom surface of the heater layer 904 by the active convection cooling device 906 to thereby create a heater layer 904 with little to no concentrated temperature gradient.

In some embodiments, one or more active convection cooling devices similar to the active convection cooling device 906 may be implemented below the heater layer 904. For example, four active convection cooling devices may be disposed at the four corners of the bottom surface of the heater layer 904 thereby dispersing the heat to the corners of the heater layer 904.

In further embodiments, a custom heater layer with an open center may be implemented in the heated build platform 800 in lieu of the heater layer 904. In this example, the heat generated by the open center heater would naturally be concentrated at the corners of the open center heater layer. In still further examples, the active convection cooling device 906 may not exceed seventy-five percent (75%) surface contact with the heater layer 904.

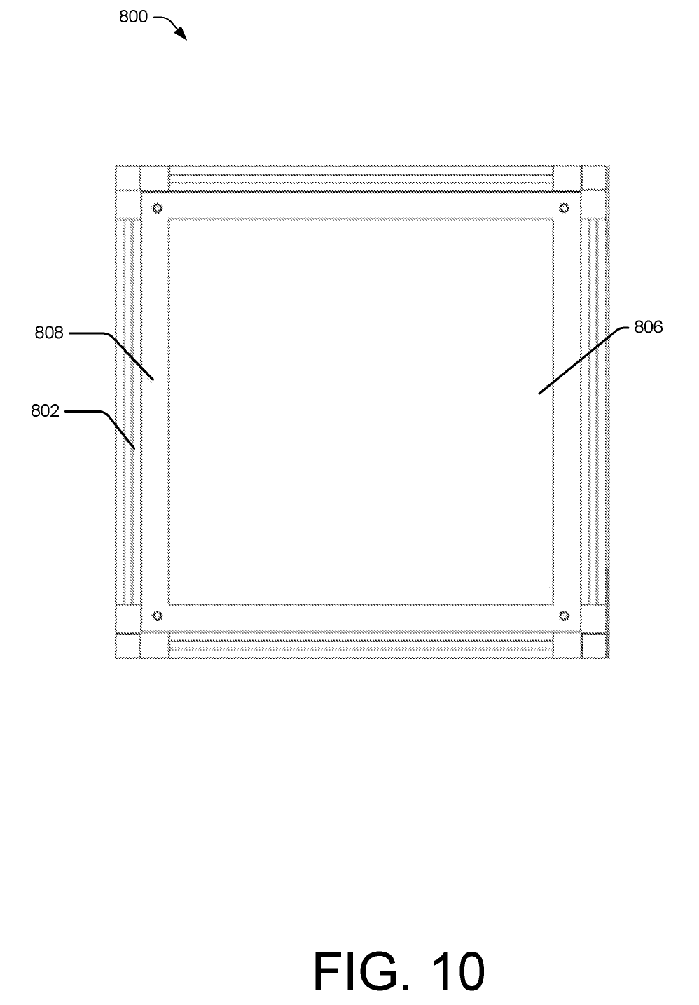

FIG. 10 is a top view of the heated build platform 800. As described above with reference to FIG. 8, the heated build platform 800 implements the frame 802, the low surface energy thermoplastic layer 806, and the high flatness and dimensional stability layer 808. In the illustrated example, the frame 802 may be disposed around the perimeter of the heated build platform 800 and may serve to stabilize the heated build platform 800. The high flatness and dimensional stability layer 808 may provide a flat and rigid layer for the heated build platform 800. Additionally, the low surface energy thermoplastic layer 806 provides a chemical bond between the build material and the heated build platform 800.

In some examples, the low surface energy thermoplastic layer 806 may be disposed directly above the high flatness and dimensional stability layer 808 and may be thin in nature, allowing for a form fitting interaction between the two layers. More specifically, the low surface energy thermoplastic layer 806 may be directly adjacent to the high flatness and dimensional stability layer 808 and the dimensions of the low surface energy thermoplastic layer 806 may be smaller than those of the high flatness and dimensional stability layer 808. In other examples, the low surface energy thermoplastic layer 806 and the high flatness and dimensional stability layer 808 may also be implemented as one layer, providing a more efficient and compact design for the heated build platform 800.

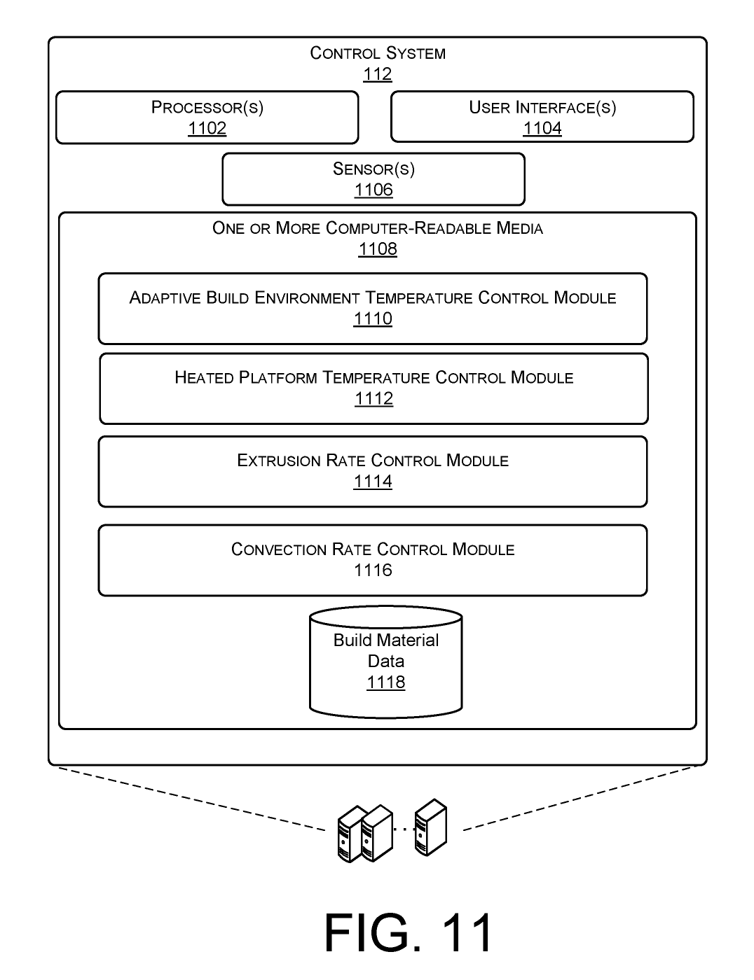

FIG. 11 illustrates an example architecture of the control system 112 of the 3D print system 100 of FIG. 1. The control system 112, collectively comprises processing resources, as represented by processor(s) 1102, user interface(s) 1104, sensor(s) 1106 and one or more computer-readable storage media 1108. The sensor(s) 1106 may be configured to collect data regarding the 3D print system 100 and transmit that data to the one or more modules of the one or more computer-readable storage media 1108. For example, the one or more sensor(s) 1106 may collect data regarding the type of build material being used, the temperature of the 3D print environment 106 and its various components, the temperature of the build platform 104 and its various components and layers, etc. and for transmission to the one or more computer-readable storage media 1108.

The computer-readable storage media 1106 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may also be stored within the one or more computer-readable media 1108 and configured to execute on the processors 1102. For example, the one or more computer-readable media 1108 may store an adaptive build environment temperature control module 1110, a heated platform temperature control module 1112, the extrusion rate control module 1114, and a convection rate control module 1116. The one or more computer-readable media 1108 may also store data, such as build material data 1118 associated with timing and temperature information related to materials that may be used to 3D print an object.

In some embodiments, the adaptive build environment temperature control module 1110 is configured to control the temperature of the 3D print environment 106. For example, a user may enter the build material data 118 into the user interface(s) 1104, such as the glass transition temperature, and the user interface(s) 1104 may transmit this information to the adaptive build environment temperature control module 1110. The one or more sensor(s) 1106 may gather information regarding the temperature of the 3D print environment 106 and transmit this information to the adaptive build environment temperature control module 1110. The adaptive build environment temperature control module 1110 may then utilize the build material data 1118, along with the temperature of the 3D print environment 106 from the sensor(s) 1106, determine that the temperature needs to be adjusted to a certain temperature during the cooling phase of printing, and adjust the temperature of the 3D print environment 106 accordingly.

In other embodiments, the heated platform temperature control module 1112 is configured to control the temperature of the build platform 104. For example, a user may enter the build material data 1118 into the user interface(s) 1104, such as the glass transition temperature, and the user interface(s) 1104 may transmit this information to the heated platform temperature control module 1112. The one or more sensor(s) 1106 may gather information regarding the temperature of the build platform 104 and transmit this information to the heated platform temperature control module 1112. The heated platform temperature control module 1112 may then utilize the build material data 1118 user interface(s) 1104, along with the temperature of the build platform 104 from the sensor(s) 1106, determine that the temperature needs to be adjusted to a certain temperature for auto-ejection to occur, and adjust the temperature of the build platform 104 accordingly.

In some examples, the extrusion rate control module 1114 is configured to modulate the rate at which the build material is extruded from the material source 110 through the extrusion head 108 as well as if the drive is forward or retracted backward. For example, the sensor(s) 1106 may detect the rate at which the build material is being extruded and transmit this information to the extrusion rate control module 1114. The extrusion rate control module 1114 may utilize this information and the build material data 1118 to determine that the build material is being extruded at a rate too fast to be supported by the build platform 104 and may adjust the rate accordingly.

In further examples, the convection rate control module 1116 is configured to modulate the rate at which fluids or current are being supplied to the 3D print environment 106. For example, the sensor(s) 1106 may gather data regarding the flow rate of fluid into the 3D print environment 106 and transmit this information to the convection rate control module 1116. The convection rate control module 1116 may utilize this information to determine if the fluid flow rate needs to be adjusted.

As noted above, the control system 112 may also include one or more communication interfaces 1104, which may support both wired and wireless connection to various networks, such as cellular networks, radio, WiFi networks, short-range or near-field networks (e.g., Bluetooth®), infrared signals, local area networks, wide area networks, the Internet, and so forth. For example, the communication interfaces 1104 may allow the computing device to stream audio signals captured from the environment around the computing device to the device management service for parsing.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A build platform system for 3D printing comprising:
a low surface energy thermoplastic layer, the low surface energy thermoplastic layer disposed at a top surface of the build platform and creating a bond with a layer of build material during printing;
a high flatness and dimensional stability layer, the high flatness and dimensional stability layer disposed adjacent to a bottom surface of the low surface energy thermoplastic layer;
a heat spreading layer, the heat spreading layer disposed adjacent to a bottom surface of the high flatness and dimensional stability layer;
a high thermal density layer, the high thermal density layer disposed adjacent to a bottom surface of the heat spreading layer;
a heater layer, the heater layer including a heat source and disposed adjacent to a bottom surface of the high thermal density layer;
an active convection cooling device, the active convection cooling device including a fan and a heat sink and disposed adjacent to a portion of the bottom surface of the heater layer;
a frame, the frame located at the perimeter of the build platform; and
a bed leveling device.

2. The build platform system of claim 1, wherein the portion of the bottom surface of the heater layer comprises less than seventy-five percent of the bottom surface of the heater layer.

3. The build platform system of claim 1, wherein the low surface energy thermoplastic layer is comprised of a low shrinkage rate material, where the low shrinkage rate material has a shrinkage rate lower than a build material shrinkage rate.

4. The build platform system of claim 3, wherein the low shrinkage rate material includes fiber reinforced composites.

5. The build platform system of claim 1, wherein the low surface energy thermoplastic layer, high flatness and dimensional stability layer, heat spreading layer, high thermal density layer, and heater layer are laminated together with an adhesive.

6. The build platform system of claim 5, wherein the adhesive comprises a material having an adhesion of p thirty ounces per inch (30 oz/in) and a continuous operating temperature of at least twenty degrees Celsius (20 C) greater than the maximum intended operating temperature for the build platform system.

7. The build platform system of claim 1, wherein the high flatness and dimensional stability layer is comprised of a rigid material with a surface flatness tolerance of less than half a millimeter (0.5 mm).

8. The build platform system of claim 1, wherein the bond between the low surface energy thermoplastic layer and the build material is broken when printing is complete.

9. A build platform system for 3D printing comprising:
a heater layer, the heater layer disposed at a bottom surface of the build platform system;
a high thermal density layer, the high thermal density layer disposed at a top surface of the heater layer;
a heat spreading layer, the heat spreading layer disposed at a top surface of the high thermal density layer;
a high flatness and dimensional stability layer, the high flatness and dimensional stability layer disposed at a top surface of the heat spreading layer; and
a low surface energy thermoplastic layer, the low surface energy thermoplastic layer disposed at a top surface of the build platform system.

10. The build platform system of claim 1, further comprising:
an active convection cooling device, the active convection cooling device including a fan and one or more heat sink components disposed adjacent to a portion of the bottom surface of the heater layer;
a frame; and
a bed leveling device.

11. The build platform system of claim 1, wherein the low surface energy thermoplastic layer is exposed to an interior of a build environment and is bonded with a layer of build material during printing.

12. The build platform system of claim 1, wherein the low surface energy thermoplastic layer is comprised of a low shrinkage rate material, wherein the low shrinkage rate material has a shrinkage rate lower than a build material shrinkage rate.

13. The build platform system of claim 2, wherein the low shrinkage rate material includes fiber reinforced composites.

14. The build platform system of claim 10, wherein the one or more heat sink components are positioned at one or more corners of the portion of the bottom surface of the heater layer.

15. The build platform system of claim 1, wherein the heat spreading layer is comprised of a rigid material with a surface flatness tolerance of less than half a millimeter (0.5 mm).

16. The build platform system of claim 1, wherein the heat spreading layer is comprised of a material with a thermal conductivity of more than twenty-five watts per meter Kelvin (25 W/m·K).

17. A heated build platform for 3D printing comprising:
a low surface energy thermoplastic layer, the low surface energy thermoplastic layer exposed to an interior of a build environment and forming a bond with a layer of build material during printing;
a heater layer, the heater layer including a heat source and disposed beneath the low surface energy thermoplastic layer; and
an active convection cooling device, the active convection cooling device including a fan and one or more heat sink components and disposed adjacent to a portion of the bottom surface of the heater layer.

18. The heated build platform for 3D printing of claim 17, wherein the one or more heat sink components are disposed at one or more corners of the portion of the bottom surface of the heater layer to invert the temperature gradient of the heater layer.

19. The heated build platform for 3D printing of claim 17, wherein the low surface energy thermoplastic layer is comprised of a low shrinkage rate material having a shrinkage rate lower than a build material shrinkage rate.

20. The heated build platform for 3D printing of claim 19, wherein the differential between the low shrinkage rate material of the low surface energy thermoplastic layer and the build material shrinkage rate releases the bond between the low surface energy thermoplastic layer and the build material when printing is complete.
